(19) United States
(12) Patent Application Publication
(10) Pub. No.: US 2007/0039163 A1
(43) Pub. Date: Feb. 22, 2007

(54) Method for producing a cup-shaped annular part having an inner toothing, a cup-shaped preform and a cup-shaped annular part

(76) Inventor: Manfred Vogel, Kappelrodeck (DE)

Correspondence Address: JACOBSON HOLMAN PLLC, 400 SEVENTH STREET N.W., SUITE 600, WASHINGTON, DC, 20004, US

(21) Appl. No.: 10/554,053

(22) PCT Filed: Apr. 22, 2004
(86) PCT No.: PCT/DE04/00840

§ 371 Date: Oct. 24, 2005

(30) Foreign Application Priority Data
Apr. 22, 2003 (DE) 103 18 178.4

(51) Int. Cl. B23P 13/04

(52) U.S. Cl. 29/557

(57) ABSTRACT

The invention relates to a method for producing a cup-shaped annular part (2′) having an inner toothing. The invention also relates to a cup-shaped preform and to a cup-shaped annular part.

This is a nationalization of PCT/DE04/000840 filed Apr. 22, 2004 and published in German.

The present invention relates to a method for producing a cup-shaped annular part having an inner toothing.

Usually, such cup-shaped annular parts having an inner toothing are produced by producing the teeth of the inner toothing on the inner wall of an annular element by using a process of striking and/or a different machining operation. If such annular parts that are used, for example in automatic gearboxes, as internal geared wheels for planetary gears, are required to have a mechanical connection to their longitudinal central axis, they are usually connected to a separately produced hub part so that the result is an annular part with the shape of a cup on the whole. The annular part is connected to the hub part, for example by using a plug-in connection or a screw connection.

In the older patent application DE 100 54 399.5, a method and a device for producing a single-piece cup-shaped annular part having an inner toothing is described in which a cup-shaped preform is inserted between a counterholder that can be activated using a hydraulic piston and a pressure punch that can be activated using an additional hydraulic piston. A mandrel part that has an external profile that corresponds to the toothing to be produced on the inner wall of the preform is inserted into the interior space of the preform.

In a forming operation, the counterholder is pressed against the floor of the preform and the annular pressure punch is pressed against the front surface of the cylindrical edge of the preform. In order to prevent the material of the preform from giving way and/or flowing radially outwards, the preform is surrounded by a drawing ring that exerts a counter pressure in the radial direction.

The objective of the present invention is to specify a method for producing a priceworthy, cup-shaped annular part that is designed as a single piece and consists of an annular element having an inner toothing and a hub part. Said method enables the inner toothing of the annular element to extend up to the level of the floor space of the hub part using a comparatively smaller discharge area. As a result, for example in the later application in an automatic gear, spur gear wheels, particularly planetary wheels, can extend practically up to the level of this floor space and can comb with the inner toothing of the annular element even in this area.

The present invention achieves this objective and is characterized in that at least some of the following features are implemented into the invention.
1) A cup-shaped preform having an annular element and a hub part are arranged in a matrix part.
2) A punch part that has an outer toothing on its outer wall that corresponds to the inner toothing to be produced in the annular element is inserted into the interior space of the preform.
3) With the aid of an annular punch part, pressure is exerted in a forming step on the front surface of the open end of the preform by carrying out a relative movement between the matrix part and the punch part.
4) An annular groove is provided in the floor space of the hub part in the corner region between the inner surface of the annular element and the floor space of the hub part.
5) Pressure is exerted on the front surface of the open end of the preform so that material of the preform flows across the punch part into the area of the groove.

The essential advantage of the present invention is that the teeth of the inner toothing of the annular element of the cup-shaped annular part can extend practically up to the level of the floor space of the hub part so that spur gear wheels, particularly planetary wheels can comb with the inner toothing up to the level of the floor space of the hub part. This enables a design that is very compact in the axial direction. Furthermore, the individual teeth of the annular parts produced according to the present method, particularly even in the region of the floor space of the hub part are designed to be extremely sharp-edged and precisely in line with the contour. For this purpose, a preform is used according to the present method in which an indentation and/or a groove is arranged in the corner region between the floor space of the hub part and the inner surface of the annular wall of the annular element. This enables the production of the inner toothing directly up to the level of the floor space using a minimum discharge area during the forming process since material can flow across the level of the hub part and into the indentation and/or groove during the forming process. Therefore, spur gear wheels, for example planetary wheels can extend closer to the floor space of the hub part. Thus, the axial overall length of the present annular part is reduced still further.

For an especially accurate configuration of the teeth, in a particularly preferred embodiment of the present invention, the grove is inserted into the preform in such a way that its radially outer side forms an extension of the inner surface of the annular element of the preform. In the same forming step, an outer toothing can be produced on the outer side of the annular part with particular ease and advantage due to the fact that the matrix part has an inner toothing on its inner surface that corresponds to the outer toothing. For producing an annular part having an axle pin, it is possible to use a matrix part that has a central recess for accommodating the axle pin. For producing an annular part having a central borehole in the hub part, it is possible to use a preform that has a central borehole in the hub part. A drawing ring can be used that surrounds the region of the annular element of the preform that projects over the matrix part in order to exert a radial counter pressure during the forming process. Here, the drawing ring can be designed as a single piece with the matrix part.

The cup-shaped preform for implementing the method according to the present invention has an annular groove in the end area between the annular element and the floor space of the hub part, whereby the radially outer side of the groove can form an extension of the inner surface of the ring element for the purpose of an accurate configuration of the teeth.

The present invention and its embodiments are explained more elaborately in the following description by reference to the figures, of which:

FIG. 1 is a schematic illustration of a device for implementing the method according to the present invention for producing an annular part;

FIG. 2 illustrates an annular part that has been produced according to a preferred embodiment of the present invention; and

FIGS. 3 to 6 illustrate additional embodiments of the present invention.

According to FIG. 1, the device for producing an annular part 2′ (FIG. 2) according to the present method essentially has a matrix part 1 that can accommodate a cup-shaped preform 2 having a hub part 11 and an annular element 3 that extends perpendicularly to the hub part. Furthermore, the matrix part has a punch part 4 that dips into the interior space of the preform 2 and an annular pressure punch 5. On its outer wall, the punch part 4 has an outer toothing 7 that corresponds to the inner toothing 6 to be produced in the annular element 3.

The matrix part 1 can be provided with a single-piece or a two-piece design so that it can accommodate the cup-shaped preform 2. In order to prevent the material of the preform in the upper region from giving way and in order to bring about a radial flow of the material into the toothing region, a schematically illustrated drawing ring 20 that is known per se is provided. Said drawing ring surrounds the region of the annular element 3 of the preform 2 that projects over the matrix part 1. Moreover, said drawing ring exerts a radial counter pressure during the forming process. This drawing ring 20 can also be designed with the matrix part 1 as a single piece.

In order to implement the forming process, a preform 2 is first inserted into the interior space of the matrix part 1. Thereafter, the punch part 4 is inserted with its outer toothing 7 into the interior space of the preform 2. Then the matrix part 1 and/or the annular pressure punch 5 that rests against the front surface of the open end of the preform 2, are moved relative to one another e.g. hydraulically so that the preform 2 is formed into the annular part 2′ (FIG. 2) to be produced, whereby the outer toothing 7 of the punch part 4 is pictured with a sharp edge as the inner toothing 6 in the inner wall of the annular element 3′ of the annular part 2′. For this purpose, it is particularly important for the outer toothing 7 of the punch part 4 to extend up to the front surface 14 of the punch part 4. This ensures that the outer toothing 7 can be guided up to the floor space 13 during the insertion of the punch part 4 into the preform 2. Therefore, in the subsequent forming process, in which a relative movement is carried out between the pressure punch 5 and the matrix part 1, the material of the preform 2 flows into the outer toothing 7 of the punch part 4 and into the corner region between the annular element 3 and its floor space 13 so that the ends of the inner toothing 6 are pictured with shape accuracy in the corner region of the formed annular part 2′ between the floor space 13′ of the hub part 11′ and the inner surface 12′ of the annular element 3′. FIG. 2 illustrates the annular part 2′ that is produced in this manner from the preform 2. In other words, by using the present method, it is feasible that the inner toothing 6 extends up to the said floor space 13′ of the annular part 3′ exactly and with shape accuracy.

At this juncture, it must be pointed out that the toothings 6, 7 can be axially extending toothings as illustrated or also helical toothings.

According to FIG. 3, the preform 2 has an annular indentation and/or groove 9 according to the present invention in the corner region between the inner surface 12 of the annular wall of the annular element 3 and the floor space 13 of the hub part 11. Due to this indentation and/or groove, it is feasible that when forming the preform 2 into the annular part 2′, the inner toothing 6 produced in the annular element 3′ extends up to the level of the floor space 13′ of the hub part 11′. This is because the extruded and/or flowing material of the preform 2 can flow across the punch part 4 and into the region of the groove 9. In this connection, it is particularly important for the radially outer side 9′ of the groove 9 to form the most accurate extension possible of the inner surface 12 of the annular element 3 of the preform 2.

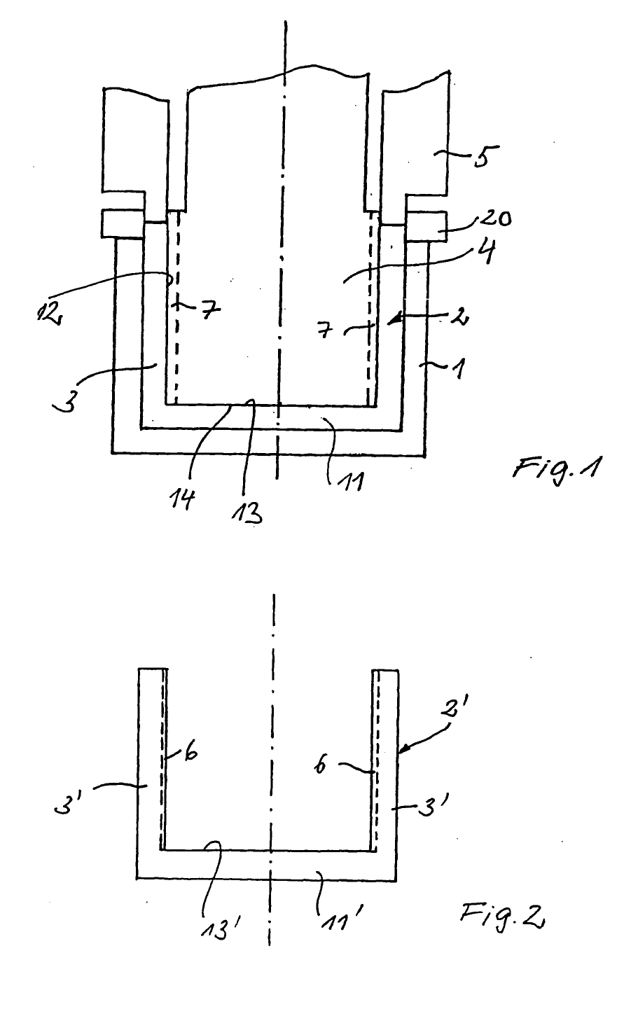

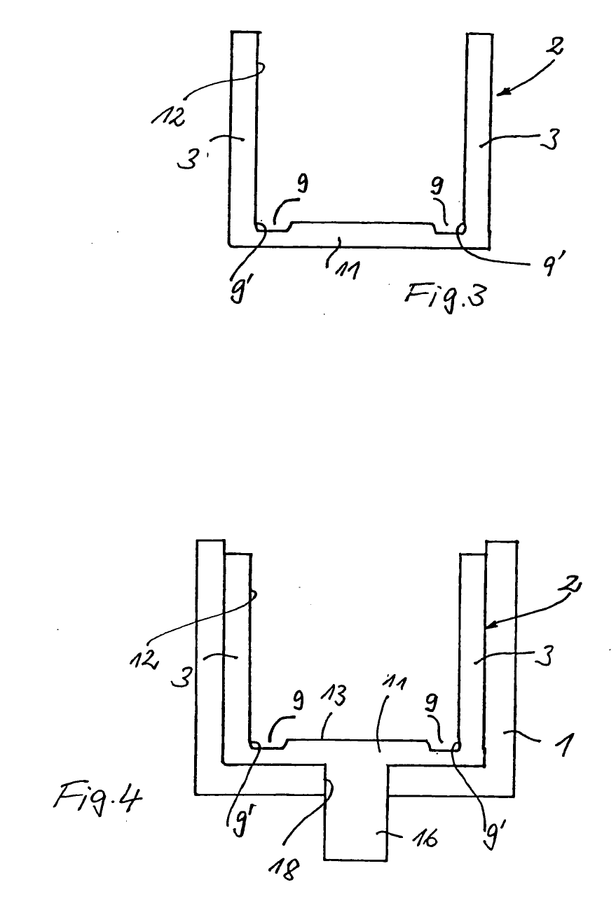

FIG. 4 illustrates an additional preform 2 and a matrix part 1 for producing a cup-shaped annular part 2′ having a molded axle pin 16. In this case, the matrix part 1 has a central recess 18 that is provided with a design, which is preferably complementary to the shape of the axle pin 16 and can accommodate the latter during the forming process.

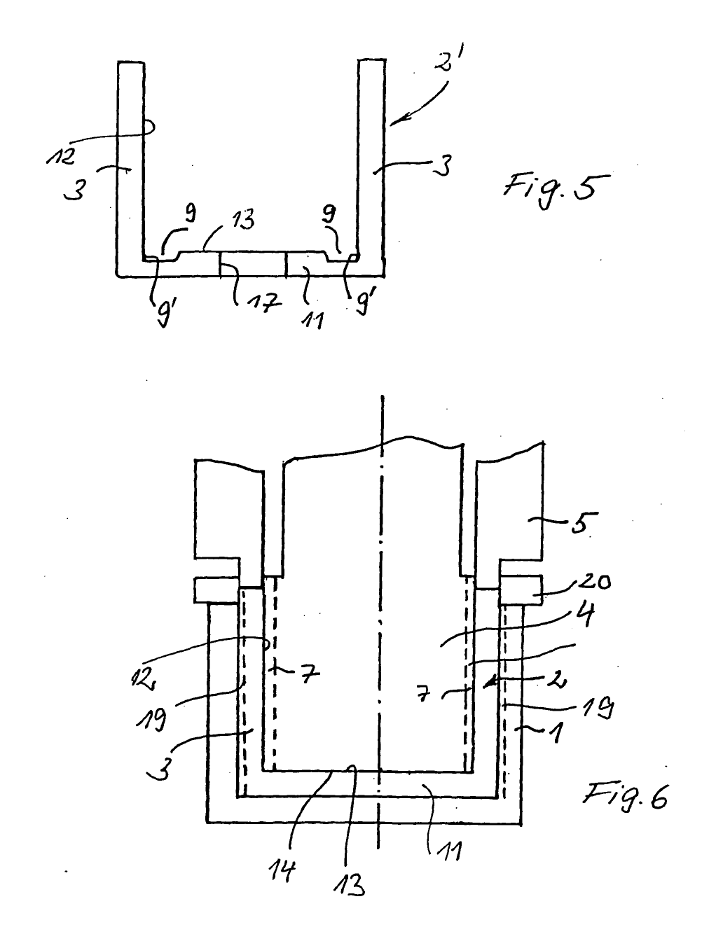

FIG. 5 illustrates an additional embodiment of the present invention in which the preform 2 (and therefore even the annular part 2′ produced from it) has a central borehole 17 in the hub part 11.

Finally, FIG. 6 illustrates an embodiment of the present invention in which, in addition to the inner toothing 6, an outer toothing is simultaneously molded on the outer side of the annular element 3 in one and the same forming step. For this purpose, the matrix part 1 has a corresponding inner toothing 19 on its inner surface. The outer toothing can have the shape of a straight toothing or a helical toothing as well as a plug-in toothing and a meshing toothing.

1. Method for producing a cup-shaped annular part (2′) having an inner toothing (6), whereby a cup-shaped preform having an annular element (3) and a hub part is arranged in a matrix part, whereby a punch part that an outer toothing has on its outer wall that corresponds to the inner toothing (6) that is to be produced in the annular element (3) is inserted into the interior space of the preform and whereby a pressure is exerted in a forming step on the front surface of the open end of the preform by carrying out a relative movement between the matrix part and the punch part with the aid of an annular punch part, characterized in that an annular grove is provided in the floor space of the hub part in the corner region between the inner surface of the annular element (3) and the floor space of the hub part so that material of the preform flows across the punch part into the region of the groove when exerting pressure on the front surface of the open end of the preform.

2. Method, particularly pursuant to claim 1, characterized in that, the groove is inserted into the preform in such a way that its radially outer side is an extension of the inner surface of the annular element (3) of the preform.

3. Method, particularly pursuant to claim 1, characterized in that an outer toothing is produced on the outer side of the annular part (2′) in the same forming step in that the matrix part has an inner toothing on its inner surface that corresponds to the outer toothing.

4. Method, particularly pursuant to claim 1, characterized in that, for producing an annular part (2′) having an axle pin, a matrix part is used that has a central recess for accommodating the axle pin.

5. Method, particularly pursuant to claim 1, characterized in that, for producing an annular part having a central borehole in the hub part, a preform is used that has a central borehole in the hub part.

6. Method, pursuant to claim 1, characterized in that, a drawing ring is used that surrounds the region of the annular element (3) of the preform that projects over the matrix part in order to exert a radial counterpressure during the forming process.

7. Method, particularly pursuant to claim 6, characterized in that, the drawing ring is provided with a single-piece design with the matrix part.

8. Cup-shaped preform, particularly for implementing a method pursuant to claim 1, characterized in that it has an annular groove in the end region between the annular element (3) and the floor space of the hub part.

9. Cup-shaped preform, particularly pursuant to claim 8, characterized in that the radially outer side of the groove forms an extension of the inner surface of the annular element (3).

10. Cup-shaped annular part, produced particularly according to a method pursuant to claim 1, whereby the annular part comprises an annular element (3) having an inner toothing and a hub part, characterized in that the teeth of the inner toothing of the annular element (3) extend exactly up to the level of the floor space of the hub part.

11. Cup-shaped annular part, produced particularly in a cup shape pursuant to claim 8, whereby the annular part comprises an annular element (3) having an inner toothing and a hub part, characterized in that the teeth of the inner toothing of the annular element (3) extend exactly up to the level of the floor space of the hub part.
